(19) United States
(12) Patent Application Publication
(10) Pub. No.: US 2009/0009906 A1
(43) Pub. Date: Jan. 8, 2009

(54) Transducer Assembly and Data Storage Device Including the Transducer Assembly

(75) Inventors: Wayne Allen Bonin, North Oaks, MN (US); Earl Chrzaszcz Johns, Sewickley, PA (US); Yongjun Zhao, Pittsburgh, PA (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/772,353

(22) Filed: Jul. 2, 2007

(51) Int. Cl. G11B 5/012

(52) U.S. Cl. 360/86

(57) ABSTRACT

An apparatus includes a storage medium, a transducer positioned adjacent to the storage medium and along an axis, and first and second support members connected to the transducer at positions that are spaced apart in the direction of the axis.

### FIELD OF THE INVENTION

This invention relates to data storage devices and, more particularly, to transducer assemblies for use in data storage devices.

### BACKGROUND OF THE INVENTION

Probe storage devices have been developed to provide small size, high capacity, low cost data storage devices. Probe recording requires relative movement between a storage medium and an array of transducers, also referred to as probes, tips or heads, that are used to subject the storage medium to electric or magnetic fields. The storage medium can be a planar thin film structure.

Probe-based data storage devices use a large number of transducers moving relatively slowly over a storage medium surface, with each transducer needing to move only a relatively small distance with respect to the medium, in a manner similar to a Scanned Probe Microscope (SPM). To maximize the achievable recording density, the transducers are generally operated in physical contact with the surface of the storage medium.

Devices have been proposed that include suspensions for supporting the transducers that are similar to the cantilever springs used in SPMs. Since these springs are flexible in all directions, when placed in contact with the storage medium, they not only deflect freely in a direction perpendicular to the surface of the storage medium (i.e., the Z-axis), but they also deflect rather easily side to side, which can introduce both X-Y position errors and Z-axis spacing problems.

The cantilever spring suspension suffers from undesired angular alignment changes, both from lateral frictional forces from the X-Y scanning motion, and from any Z-axis motion due to undulations in the storage medium, which the suspension must allow the transducer to follow.

There is a need for a transducer assembly that allows placement of the transducers in contact with the storage medium but resists undesirable movement parallel to the surface of the storage medium.

### SUMMARY OF THE INVENTION

In a first aspect, the invention provides an apparatus including a storage medium, a transducer positioned adjacent to the storage medium and along an axis, and first and second support members connected to the transducer at positions that are spaced apart in the direction of the axis.

An actuator can be included for moving the transducer along the axis. The actuator can comprise an electrostatic actuator. The electrostatic actuator can include a first electrode coupled to the transducer, and a second electrode separated from the first electrode in the direction of the central axis.

The axis of the transducer can be positioned substantially normal to a surface of the storage medium. Each of the first and second support members can include a symmetrical planar spring. The symmetrical planar spring can include a base, and a plurality of spring arms extending radially from the base to a frame. The spring arms can lie along mutually perpendicular axes.

### BRIEF DESCRIPTION OF THE DRAWINGS

FIG. 1 is a perspective view of a probe storage device that can be constructed in accordance with an aspect of the invention.

FIG. 2 is a cross-sectional view of a probe storage device constructed in accordance with an embodiment of the invention.

FIG. 3 is an isometric view of a transducer assembly constructed in accordance with an aspect of the invention.

FIGS. 4 and 5 are side views of the transducer assembly of FIG. 3.

FIGS. 6 and 7 are cross-sectional views of a transducer assembly constructed in accordance with another aspect of the invention.

FIG. 8 is a cross-sectional view of another transducer assembly.

FIG. 9 is a cross-sectional view of a transducer tip.

FIG. 10 is a plan view of a plurality of plating strips.

### DETAILED DESCRIPTION OF THE INVENTION

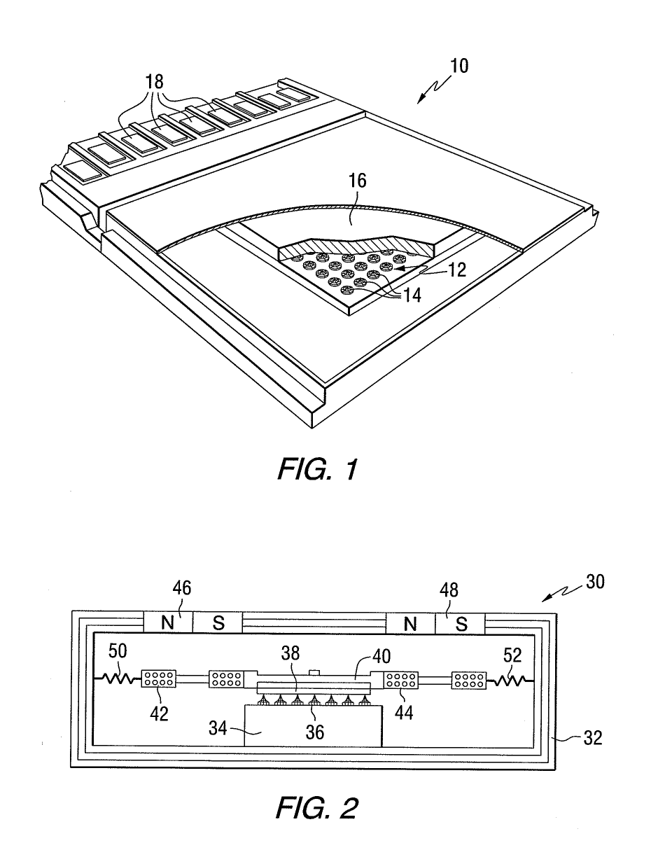

Referring to the drawings, FIG. 1 is a perspective view of a probe storage device 10 that can be constructed in accordance with an aspect of the invention. In the storage device 10 of FIG. 1, an array 12 of transducers 14, also called probes, tips, or heads, is positioned adjacent to a storage medium 16. The ends of the transducers 14 and a recording surface of the storage medium 16 lie in planes that are generally parallel with each other. The transducers 14 are electrically connected to connectors 18 through read and/or write channel circuitry, not shown. Either the storage medium 16 or the transducer array can be coupled to at least one actuator (not shown in this view), which is configured to provide relative movement between the storage medium 16 and the transducers of the array 12. This movement causes individual storage locations or domains on the medium 16 to be moved relative to the transducers. Each transducer can include one or more electrodes. The storage medium in the example of FIG. 1 can be, for example, a ferroelectric, magnetic or optical storage medium. However, the invention is not limited to any particular type of storage medium.

An example system may have a 32 by 32 array of transducers for recording and reading data from/to the storage medium. The large number of transducers is required to access the entire medium surface. In one example system, all of the transducers would be in contact with the medium at all times, but that increases the friction significantly, by a factor of 32 for a 32 by 32 array, over what it would be if only one row of probes is active in reading or recording at any particular time. An operating mode in which only a row of the transducers are in contact with the storage medium at any particular time, would reduce the power used to overcome friction in moving the probes by 32 times, and would also reduce the effect of wear between the transducers and the storage medium by the same amount.

Probe storage devices include actuators and suspension assemblies for providing relative movement between the storage medium and an array of transducers. FIG. 2 is a cross-sectional view of a probe storage device 30. The device includes an enclosure 32, also referred to as a case, base, or frame, which contains a substrate 34. An array of transducers 36 is positioned on the substrate. The transducers extend upward to make contact with a storage medium 38. In this example, the storage medium 38 is mounted on a movable member, or sled 40. Relative movement between the storage medium and the transducer array is provided by electromagnetic actuators that include coils and magnets. Coils 42 and 44 are mounted on the movable member. Magnets 46 and 48 are mounted in the enclosure near the coils. Springs 50 and 52 form part of a suspension assembly that supports the movable member. The enclosure 32 can be formed of, for example, injection molded plastic. While FIG. 2 shows one example of a probe storage device, it will be recognized that other known types of suspensions and actuators can be used to position the components and to provide relative movement between the transducers and the storage medium. This invention is not limited to devices that use any particular transducer array and medium positioning and/or actuating devices.

In ferroelectric probe storage devices, the transducers include at least one electrode that is used to subject the storage media to an electric field. When a transducer makes contact with the storage medium and relative movement occurs between the transducer and the storage medium, there will be a lateral friction force exerted on the transducer tip. This lateral force may cause the transducer to lose contact with the storage medium, or to contact the medium at an undesired location, as a result of torsional movement of the transducer.

In a first aspect, this invention includes two suspensions, spaced apart in the direction of a vertical Z-axis. The suspensions are referred to as support members and can be constructed of a plurality of arms that extend from a transducer to a frame or substrate. The use of two support members mechanically connected to the transducer at different locations greatly increases the resistance to tilting caused by the lateral frictional forces, while still allowing the desired Z-axis compliance.

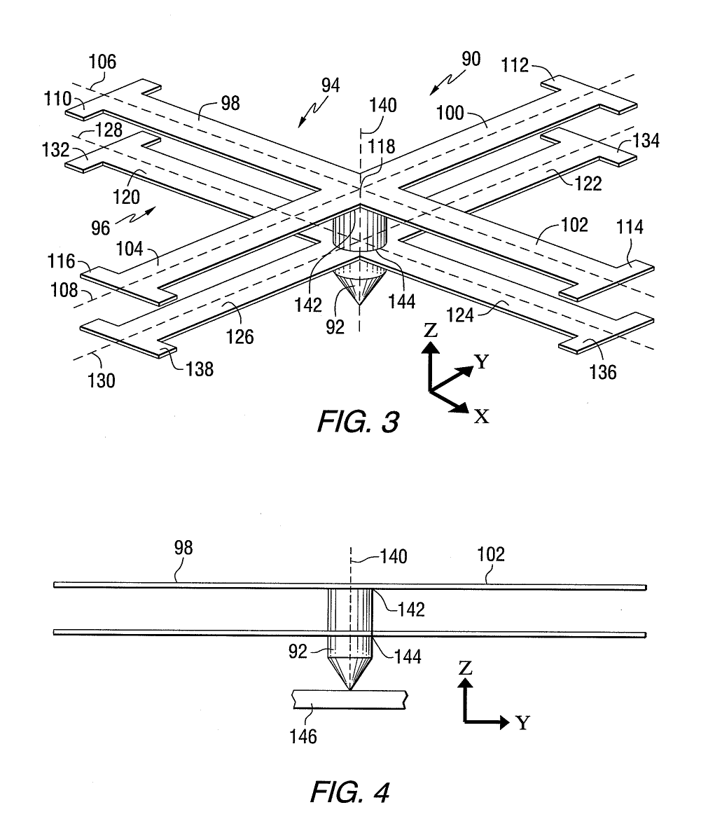

FIG. 3 is an isometric view of a transducer assembly 90 constructed in accordance with an aspect of the invention. The transducer assembly includes a transducer 92 supported by two support members 94 and 96 in a double layer configuration. A first support member 94 includes a plurality of spring beams or arms 98, 100, 102 and 104 that are positioned along orthogonal axes 106 and 108. The ends 110, 112, 114 and 116 of the arms are fixed, for example by being attached to a frame or substrate. In this example, the end of the transducer 92 is connected to a hub 118 formed by the intersection of the arms.

A second support member 96 includes a plurality of spring beams or arms 120, 122, 124 and 126 that are positioned along orthogonal axes 128 and 130. The ends 132, 134, 136 and 138 of the arms are fixed, for example by being attached to a frame or substrate. The first and second support members are separated in the direction of axis 140 and coupled to the transducer at different locations 142 and 144 that are also separated in the direction of axis 140. While the arms of the support members in this example are shown to lie along mutually perpendicular axes, the support member arms may be positioned along other axes. In addition, support members having more or fewer arms could be used.

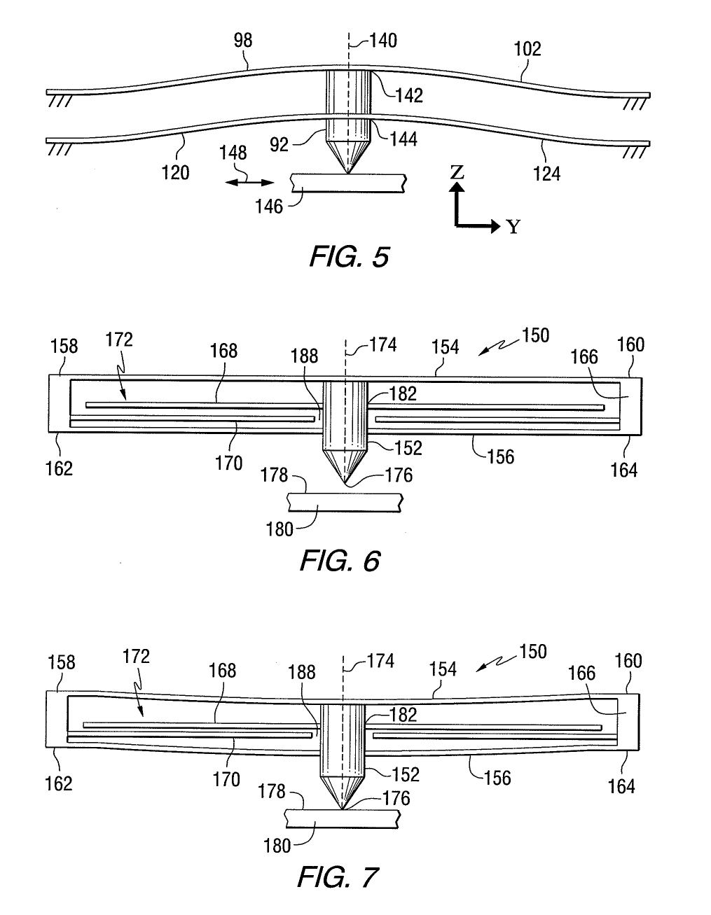

FIGS. 4 and 5 are side views of the probe assembly of FIG. 3. FIG. 4 shows the transducer assembly in an undeflected state. In FIG. 5, the transducer makes contact with a storage medium 146, and beams are deflected in the Z-direction. In FIG. 5, when the storage medium moves in the direction indicated by arrow 148, the support members maintain the relative orientation of the transducer with respect to the surface of the medium, such that the axis 140 of the transducer remains substantially normal to the surface of the storage medium.

FIGS. 6 and 7 are cross-sectional views of a transducer assembly 150 constructed in accordance with another aspect of the invention. In the examples of FIGS. 6 and 7, the transducer assembly includes a transducer 152 supported by support members 154 and 156. The support member can include a plurality of beams or spring members arranged along mutually perpendicular axes as shown in FIG. 3. The ends 158, 160, 162 and 164 of the beams of the support members are fixed, for example by being attached to a frame 166. Electrodes 168 and 170 form an electrostatic actuator 172 that can be used to move the transducer along an axis 174 to bring a tip 176 of the transducer into contact with a surface 178 of a storage medium 180. Electrode 168 is coupled to the transducer at a location 182. The edges of electrode 170 are connected to the frame. Electrode 170 includes an opening 188 through which the transducer passes. When a voltage is applied between electrodes 168 and 170, an attraction force is created between the electrodes, and the transducer moves downward along its axis. FIG. 6 shows the assembly in the inactive state and FIG. 7 shows the assembly with the electrodes activated. The electrodes can be constructed of a variety of conductive materials, such as for example, Cu, Ni, Ti or Ag. The springs can be constructed of silicon, or a metal. Insulating materials such as ceramics, polymers, or photo resists can be used to construct other components of the device. Voltage can be applied to the electrodes using connections not shown in this view. In one example, the support members can be electrically grounded.

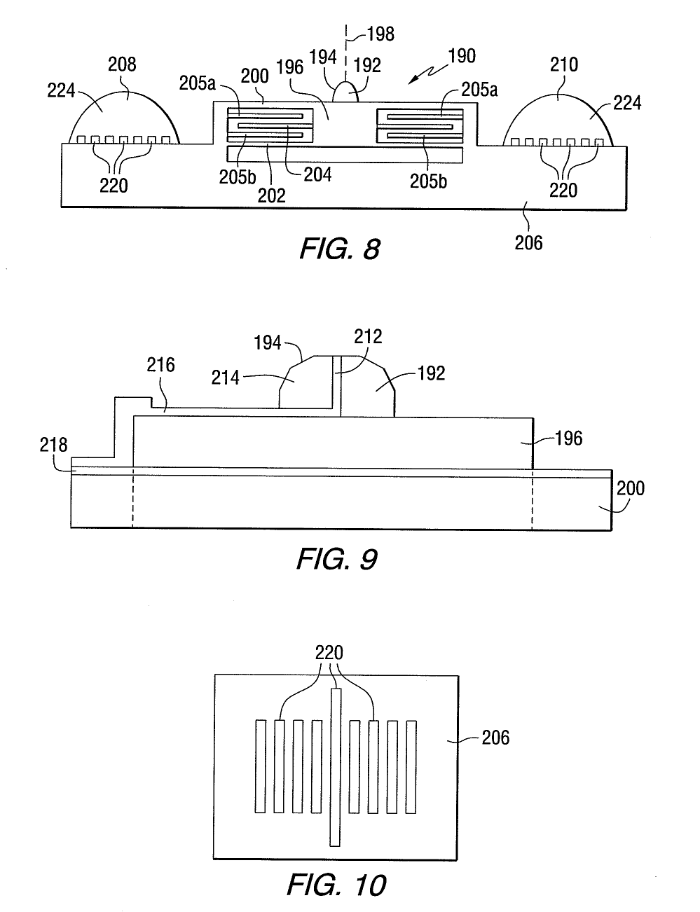

In one aspect of this invention, the transducer tip is curved to form an interface where the edges of the wear-resistant material are rounded. FIG. 8 is a side view of another transducer assembly 190 constructed in accordance with an embodiment of the invention. In FIG. 8, the transducer tip 192 includes a curved end 194. By including a curved end, there will not be any edge contact between the wear-resistant material and the storage medium when the transducer is slightly tilted. Thus an electrode in the transducer will maintain contact with the storage medium, even when the transducer is tilted with respect to the storage medium surface. In addition, by using a curved transducer tip, the transducer and the medium will be less prone to wear.

In the example of FIG. 8, the transducer assembly includes a body 196 and a tip 192. The body is positioned along an axis 198. A first support member 200 and a second support member 202 are connected to the transducer body at locations that are separated in the direction of the axis 198. The support members can include a plurality of arms as shown in FIG. 3. A first actuating electrode 204 is also connected to the transducer body, and second and third actuating electrodes 205a, 205b are mechanically connected to frame 166. A voltage between the first actuating electrode and one of the second or third actuating electrodes causes the transducer to move along the axis 198 to make contact with an adjacent storage medium. For convenience, the first actuating electrode may be electrically connected to a ground. Then a voltage applied to the second actuating electrode forces the transducer against the storage medium, and a voltage applied to the third actuating electrode pulls the transducer away from the storage medium. Depending on the spacing between the storage medium to the transducer tip, the device may include only one of the second or third actuating electrodes. The transducer assembly is mounted on a substrate 206.

The transducer, as described above, can be integrated with one or more post stand-offs to help define the spacing between the transducer tips and the storage medium. FIG. 8 is a side view of a transducer assembly that includes posts 208 and 210. The posts can help to keep the storage medium surface and transducer substrate parallel to each other during the final assembly. The posts can be located at four comers of the transducer substrate and can be fabricated several microns lower than that of the transducer tips so that contact force between the tips and the storage medium can be easily defined by this preload distance and spring constants of the transducer assembly. Also, the post surface can be tapered to a curved profile so as to reduce the wear between the post and the storage medium.

FIG. 9 is a side view of the transducer tip 192, showing a central electrode 212 within the tip. The top interface of the transducer tip contains both a wear-resistant material 214 and a conductive electrode 212, both being in contact with the storage medium during the write and read operations. The transducer body 196 is connected to the support member 200 and passes through the support member 200 as shown in FIG. 8. A conductor 216 is electrically connected to the electrode 212 and is electrically isolated from the support member by an insulating layer 218. The transducer provides both the desired conductivity and a minimum amount of wear during use. The wear-resistant material can be, for example, diamond-like carbon, oxides (Al₂O₃, ZrO₂—Y₂O₃, HfO₂), or borides. The metal electrode should be chosen so that its mechanical properties match the mechanical properties of the wear-resistant layer, thus allowing for the same type of deformation in both materials at a certain mechanical stress. The conductive materials can be, for example, metallic carbides, metallic nitrides, or a hard metal like Ru. In addition, a number of wear-resistant layers can be added subsequently to the interface definition and spring processing.

A curved interface forms a substantially uniform contact even when the transducer is slightly tilted with respect to the surface of the storage medium, which produces a more uniform contact stress. Thus, the contact stress does not vary significantly even with tilting, since the conforming contact is stable and tolerant to relative movement of the transducer and the medium. The small variation in contact stress results in a lower probability of the stress exceeding the yield strength of the transducer materials.

A curved interface can also reduce the probability of the transducer electrode losing contact with the medium surface. It results in a stable contact with a natural tolerance to relative sliding/tilting without dramatic changing of contact characteristics such as contact area. In contrast, a flat-to-flat interface can result in an unstable contact when the transducer is tilted. Therefore, a curved surface at the transducer-storage medium interface can help to maintain stable contact of the electrodes and the storage medium. A subtle variation of contact force can cause a dramatic change in contact characteristics, such as contact area shift. It can also cause the transducer electrode to lose contact with the storage medium.

In one aspect, the invention provides a transducer having a curved interface to provide a stable electrical contact with a minimum required normal load. The tapered round interface will provide a more uniform stress distribution on the contacting interface and a less concentrated stress zone in the storage medium, which are expected to result in less wear of the transducer and the storage medium. Additionally, if there is any wear of the transducer, the cross-sectional area of the conductive parts will not change, thus the electrical characteristics of the contact are stable over a longer period of time.

Friction and wear may be greatly reduced by actuating the transducers individually or in groups in the Z-axis so that only the transducers actively participating in reading or writing are in contact with the medium, and the inactive transducers are out of contact with the medium. A preferred means of actuation is to use electrostatic actuation. By applying a voltage between a movable electrode attached directly or indirectly to the transducer tip, and a second fixed electrode, the transducer may be pulled up or down, depending on the location of the electrodes. The electrostatic force is attractive, so if the fixed electrode is positioned above the movable electrode, the electrostatic force will pull the transducer up away from the medium. If placed under the movable electrode, the electrostatic force will pull the transducer down against the medium. If desired, two fixed electrodes may be included, one above and one below the movable electrode, so that the transducer may be actuated in either direction. Other possible modifications include multiple stacked electrodes to increase the total force.

To fabricate the posts 208 and 210 of FIG. 8, electroplating seeding strips can be defined on the substrate. FIG. 10 shows the top view of a plurality of seeding strips 220 on a substrate 206. Then the post material 224 is electroplated on the seeding strips to form the posts illustrated in FIG. 8. The process starts by applying a voltage to the center seeding strip, and the plating material grows to contact the adjacent seeding strips and forms a rounded post. The seeding strips can be made of material such as Cu, NiFe, Cr, or Ta, etc. The plated post material can be, for example, NiFe, or Ni, etc.

While particular examples have been described herein for the purpose of illustrating the invention and not for the purpose of limiting the same, it will be appreciated by those of ordinary skill in the art that numerous variations of the details, materials, and arrangement of parts may be made within the principle and scope of the invention without departing from the invention as described in the appended claims.

What is claimed is:

1. An apparatus comprising:
a storage medium;
a transducer positioned adjacent to the storage medium and along an axis; and
first and second support members connected to the transducer at positions that are spaced apart in the direction of the axis.

2. The apparatus of claim 1, further comprising:
an actuator for moving the transducer along the axis.

3. The apparatus of claim 2, wherein the actuator comprises:
an electrostatic actuator.

4. The apparatus of claim 3, wherein the electrostatic actuator comprises:
a first electrode coupled to the transducer; and
a second electrode separated from the first electrode in the direction of the axis.

5. The apparatus of claim 4, wherein each of the first and second electrodes comprises:
a flat plate.

6. The apparatus of claim 4, further comprising:
a frame, wherein the second electrode is connected to the frame.

7. The apparatus of claim 1, wherein the axis of the transducer is positioned substantially normal to a surface of the storage medium.

8. The apparatus of claim 1, wherein each of the first and second support members comprises:
a symmetrical planar spring.

9. The apparatus of claim 8, wherein each of the symmetrical planar springs comprises:
a base; and
a plurality of spring arms extending radially from the base to a frame.

10. The apparatus of claim 9, wherein the spring arms lie along mutually perpendicular axes.

11. The apparatus of claim 1, further comprising:
a substrate connected to the first and second support members.

12. The apparatus of claim 1, wherein the transducer comprises:
an electrode positioned along the axis; and
a wear-resistant material surrounding the electrode.

13. The apparatus of claim 1, wherein the transducer includes a rounded end.

14. The apparatus of claim 1, further comprising:
a substrate; and
a plurality of posts on the substrate.

15. The apparatus of claim 1, wherein the transducer comprises:
a body connected to the first and second support members; and
a tip extending from the body.

16. The apparatus of claim 15, wherein the tip comprises:
an electrode; and
a wear-resistant material surrounding the electrode.

17. The apparatus of claim 16, further comprising:
a conductor electrically connected to the electrode and extending along a surface of the body.

18. The apparatus of claim 17, further comprising:
an insulating layer between the conductor and the first support member.
